(19) United States
(12) Patent Application Publication
(10) Pub. No.: US 2002/0055296 A1
(43) Pub. Date: May 9, 2002

(54) ELECTRICAL CONTACT

(76) Inventors: SHOICHI MOCHIZUKI, YAMANASI (JP); YASUHIRO ONO, KANAGAWA (JP)

Correspondence Address: ROBERT W J USHER, SUITE 1515, 1133 BROADWAY, NEW YORK, NY, 10010

(21) Appl. No.: 09/295,314

(22) Filed: Apr. 26, 1999

(30) Foreign Application Priority Data
May 6, 1998 (JP) 10-123330

(51) Int. Cl. H01R 13/58

(52) U.S. Cl. 439/450

(57) ABSTRACT

An electrical contact is configured such that a root portion 36a of a contact portion 36 extending from an anchoring portion 37, which is press-fit into a fitting slot 41 provided in a receptacle housing 31, is positioned below a reference line M which interconnects the upper ends of the lateral side ends of the anchoring portion 37 which meet the fitting slots 41. In this configuration, the distance L from the root portion 36a of the contact portion 36 to the point of contact C, which meets an intermatable contact 16, is made relatively long to make the resiliency of the contact portion 36 relatively small.

### FIELD OF THE INVENTION

The present invention relates to electrical contacts which are used in an electrical connector assembly comprising two intermatable plug and receptacle connector halves.

### BACKGROUND OF THE INVENTION

In general, an electrical connector assembly used for signal transmission comprises intermatable plug and receptacle connector halves, both of which are mated with each other for establishing electrical connection through the physical contact of the electrical contacts provided in the respective connector halves. In such an electrical connector assembly, the receptacle connector half includes a plurality of receptacle contacts which are aligned in pairs and in two rows on opposite sides in the housing, and the plug contacts of the plug connector half are brought into these pairs and rows of receptacle contacts, for electrical connection. When the plug connector half is in the receptacle connector half, the plug contacts are in contact with the receptacle contacts, which are positioned outside with respect to the plug contacts and are biased inward against the plug contacts.

An example which describes the configuration of such receptacle contacts is shown in FIG. 6. The receptacle contact 50 shown in the figure is made of an electrically conductive plate material, with an anchoring portion 51 and a contact portion 52, which extends upward from the anchoring portion 51. A plurality of receptacle contacts 50 are press fit into fitting slots 54 which are provided in the housing 53 of the receptacle connector such that the anchoring portion 51 of each contact remains in the respective slot 54 as shown in the figure. As a result, the contact portion 52 of each contact extends upward in the housing and is bendable elastically around the root portion 55 of the contact portion in the plane of the plate material. These receptacle contacts 50 are provided in lateral pairs (FIG. 6 shows only one side.), and a plurality of plug contacts 56 are provided in pairs on the protrusion 57 of the plug connector. When the plug connector is inserted into the receptacle connector, the protrusion 57 comes into the contact portions 52 of the receptacle contacts, elastically bending the contact portions 52 laterally outward. In this condition, the resiliency of each contact portion provides a contact force which establishes electrical connection between the receptacle contact 50 and the plug contact 56 at the point of contact 58 as shown in broken line in the figure.

Here, the reliability of the electrical connection of the respective electrical contacts depends on the contact force acting on the point of contact 58. Therefore, it is preferable that the contact force reach a certain magnitude during the insertion and intermating of the connector halves, for all the respective electrical contacts as uniformly as possible. Thus, the receptacle contact 50 requires careful designing in consideration of the resiliency to be achieved for the contact portion. More specifically, it is preferable that the spring constant of the receptacle contact be made as small as possible, so that the variation in the contact force generated from the non-uniformity of elastic deformation of the receptacle contacts is kept as small as possible. As a method to make the spring constant smaller, the contact portion of each receptacle contact is made relatively long, i.e., the distance Lo between the root portion 55 of the contact portion 52 and the point of contact 58 is made relatively long. However, if the contact portion is lengthened, then the size of the whole connector is enlarged, so this method is not preferable.

### SUMMARY OF THE INVENTION

It is an object of the present invention to provide an electrical contact whose size is relatively small yet which can set the contact force accurately to a predetermined value during the engagement of connector halves.

An electrical contact according to the present invention is made of an electrically conductive plate material, and it comprises a base portion and a contact portion. The lateral side ends of the base portion are press-fit into a fitting slot which is provided vertically in a housing. The contact portion extends upward from the upper end of the base portion at the lateral central portion thereof, and the contact portion is elastically bendable in the plane of the plate material. This electrical contact is configured such that the root portion of the contact portion, which is continuous with the upper end of the base portion, is positioned lower than a line (e.g., the reference line M of the following embodiment) which interconnects the upper ends of the lateral side ends of the base portion which meet the fitting slot.

With this configuration for the electrical contact, the vertical distance from the root portion of the contact portion to the point of contact, which meets an intermatable contact, is made relatively long with respect to the size of the electrical contact, which is maintained relatively small. As a result, the resiliency of the contact portion is relatively small. Therefore, according to the present invention, the contact force for the engagement of the connector halves is easily adjustable to a desired value in the design of the electrical contact. Thus, the non-uniformity in the elastic forces achieved for the contact portions, which non-uniformity is a result of dimensional inaccuracy during the fabrication of the contacts, is kept relatively small by the provision of a relatively small spring constant to the contact portions. In other words, the variation in the contact forces of the contact portions which results from the dimensional inaccuracy is maintained relatively small. Furthermore, the present invention is useful in miniaturizing an electrical connector since, in the configuration of an electrical contact according to the present invention, the size of the electrical contact can be made smaller without shortening the length of the contact portion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1 shows a side view of an electrical connector assembly which includes electrical contacts according to the present invention;

FIG. 2 shows a perspective view of the section of the electrical connector assembly, which section is indicated by dimension line “A” in FIG. 1;

FIG. 3 shows a sectional view of a signal transmission portion of the electrical connector assembly in engagement;

FIG. 4 shows a sectional view of a grounding portion of the electrical connector assembly in engagement;

FIG. 5 shows a front view of the configuration of the electrical contact according to the present invention; and

FIG. 6 shows a front view of the configuration of a prior art electrical contact.

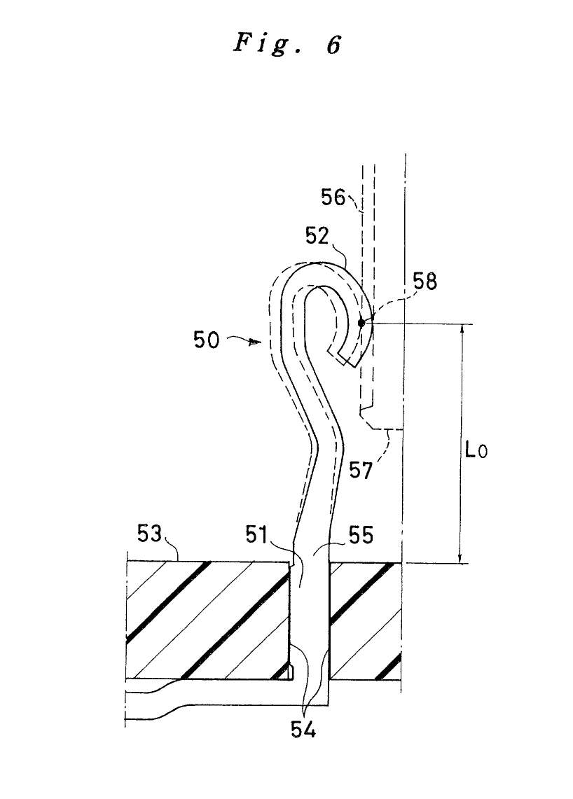

### DESCRIPTION OF THE PREFERRED EMBODIMENTS

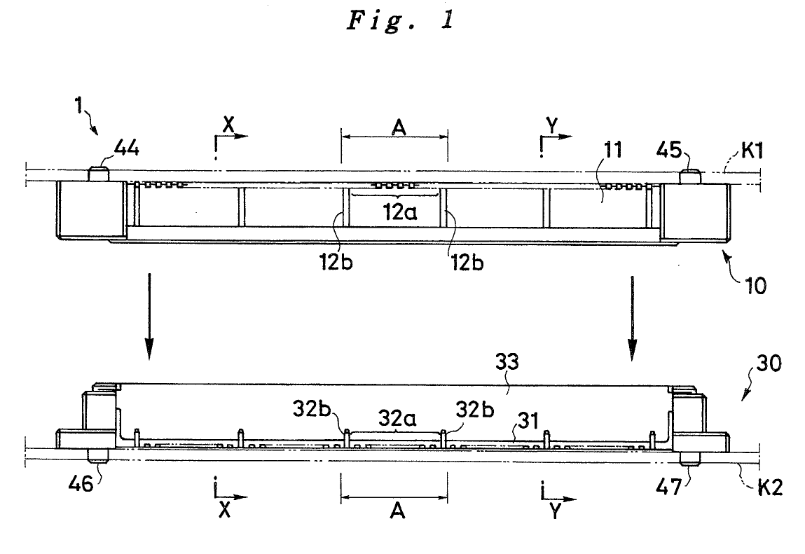

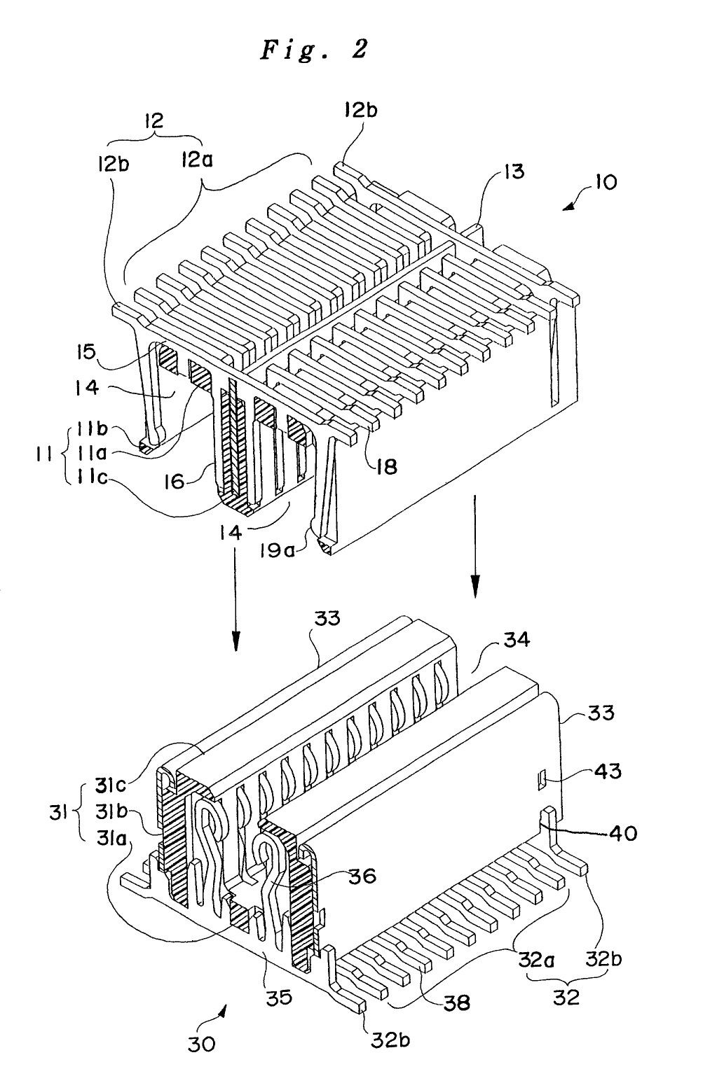

As shown in FIG. 1 and FIG. 2 (FIG. 2 is a perspective view of the section A in FIG. 1), an electrical connector assembly 1, which is provided with electrical contacts according to the present invention, comprises a plug connector 10 and a receptacle connector 30. These connector halves 10 and 30 are mated to each other to bring the electrical contacts 12 of the plug connector and the electrical contacts 32 (these receptacle contacts 32 are the electrical contacts configured according to the present invention) of the receptacle connector 30 into electrical contact for signal transmission. For the sake of convenience in description, the lateral direction of FIG. 1 is defined as “back-and-forth direction”, the top-and-bottom direction thereof is defined as “up and down direction”, and the direction perpendicular to the drawing thereof is defined as “lateral direction”.

As shown in FIG. 2, the plug connector 10 has a plug housing 11 which is formed of an insulative material. This housing includes a horizontal base wall 11a, lateral side walls 11b, which extend downward from the lateral ends of the base wall 11a, and a central protrusion 11c, which protrudes downward from the center of the base wall 11a. The plug connector 10 further comprises a plurality of plug contacts 12, which are formed of an electrically conductive plate material and are aligned and retained in the plug housing 11, and a central grounding plate 13, which is made of an electrically conductive material and is positioned inside the central protrusion 11c, extending in the back-and-forth direction.

As shown in FIG. 2, on the opposite sides of the central protrusion 11c of the plug housing 11, two lateral rows of plug contacts 12 are provided, each row extending in the back-and-forth direction. There are two types of plug contacts 12: one for signal transmission and the other for electrical grounding. Each of the plug contacts 12a for signal transmission has a “L” shape, and two signal plug contacts 12a in a pair face each other on the opposite sides of the central grounding plate 13 in the plug housing 11. Each of the plug contacts 12b for grounding has a shape comparable to that in which a pair of signal plug contacts 12a are combined into a one piece at the center top of the electrical connector, and each grounding plug contact 12b is placed in a position which is comparable to that of a pair of signal plug contacts 12a.

In the plug housing 11, the lateral pairs of signal plug contacts 12a are positioned in succession in the back-and-forth direction, and the grounding plug contacts 12b are positioned to section these pairs of signal plug contacts 12a into groups (nine pairs are sectioned into a group in this embodiment).

The receptacle connector 30 has a receptacle housing 31 which is formed of an insulative material. This housing includes a horizontal base wall 31a and lateral side walls 31b, which extend upward from the lateral ends of the base wall 31a. The receptacle connector 30, which is open upward, further comprises a plurality of plug contacts 32, which are formed of an electrically conductive plate material and are aligned and retained in the receptacle housing 31, and two lateral grounding plates 33, which are made of an electrically conductive material and are positioned laterally outside the receptacle housing 31.

As shown in FIG. 2, inside the receptacle housing 31, two lateral rows of receptacle contacts 32 are provided, each row extending in the back-and-forth direction. There are two types of receptacle contacts 32: one for signal transmission and the other for electrical grounding. Each of the receptacle contacts 32a for signal transmission generally has a “L” shape with its top end being curled inward. Each of the receptacle contacts 32b for grounding has a shape comparable to that in which a pair of signal receptacle contacts 32a are combined into a one piece at the center bottom of the electrical connector. The grounding receptacle contacts 32b are positioned in a comparable way as the signal receptacle contacts 32a.

In the receptacle housing 31, the lateral pairs of signal receptacle contacts 32a are positioned in succession in the back-and-forth direction, and the grounding receptacle contacts 32b are positioned to section these pairs of signal receptacle contacts 32a into groups (nine pairs are sectioned into a group in this embodiment).

As shown in FIG. 1 and FIG. 2, the signal plug contacts 12a and the signal receptacle contacts 32a are positioned appropriately such that the respective pairs of contacts come into electrical contact when the respective connector halves are mated to each other. Also, the grounding plug contacts 12b and the grounding receptacle contacts 32b are positioned appropriately such that the respective pairs come into electrical contact when the respective connector halves are mated to each other. Therefore, in the condition where the plug connector 10 and the receptacle connector 30 are in engagement, the signal plug contacts 12a are in electrical connection with the corresponding signal receptacle contacts 32a (the portions of the electrical connector assembly where the signal contacts are in electrical connection are referred to as “signal connection portions”), and the grounding plug contacts 12b are in electrical connection with the grounding receptacle contacts 32b (the portions of the electrical connector assembly where the grounding contacts are in electrical connection are referred to as “grounding connection portions”).

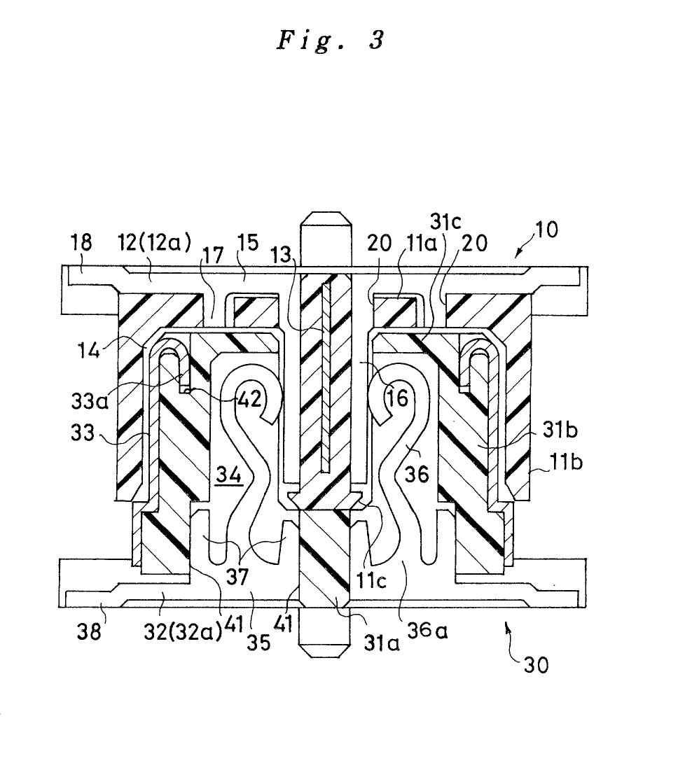

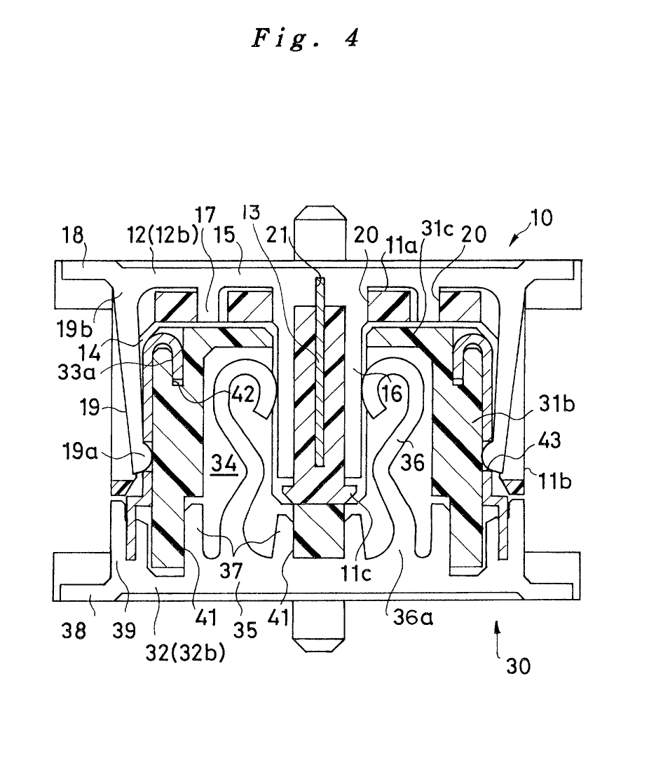

The plug connector 10 and the receptacle connector 30 are shown in engagement in FIG. 3 and FIG. 4. FIG. 3 is a cross-sectional view taken along line X-X in FIG. 1 (i.e., a view of a signal connection portion) while FIG. 4 is a cross-sectional view taken along line Y-Y in FIG. 1 (i.e., a view of a grounding connection portion). As both the connector halves 10 and are laterally symmetrical, only one sides of the symmetrical portions are marked with numerals.

As shown in FIGS. 2, 3 and 4, the plug housing 11 of the plug connector 10 comprises the base wall 11a, which is horizontally positioned, the lateral side walls 11b, which extend downward from the lateral ends of the base wall 11a, and the central protrusion 11c, which protrudes downward from the center of the base wall 11a. In this configuration, on the lower face of the base wall 11a, plug cavities 14 are defined by the lateral side walls 1b and the central protrusion 11c, the cavities being open downward.

As shown in FIG. 3, the signal plug contact 12a includes a base portion 15, which extends horizontally near the upper part of the plug connector 10, a contact portion 16, which extends downward from the inside end of the base portion 15, a protruding portion 17, which extends downward at the middle part of the base portion 15, and a lead portion 18, which is provided at the outside end of the base portion 15. On the other hand, the grounding plug contacts 12b includes the features of a pair of signal plug contacts 12a in a shape which is comparable to that of the signal plug contacts 12a combined into a one piece at the top of the electrical connector as shown in FIG. 4. Furthermore, the grounding plug contact 12b includes a pair of arm portions 19, which extend downward near the lateral outside ends, and each of the arm portions 19 further includes a raised portion 19a, which protrudes inward at the lower end thereof. In this configuration, the arm portions 19 are laterally resilient around the supporting portions 19b of the arm portions 19.

In the base wall 11a and the central protrusion 11c of the plug housing 11, fitting slots 20 are provided for attaching the signal plug contacts 12a and the grounding plug contacts 12b (slots are also provided in the lateral side walls 11b where the grounding plug contacts are positioned). During the assembly of the electrical connector, the contact portions 16 and the protruding portions 17 of the respective plug contacts are staked into these fitting slots 20. As a result, a pair of signal plug contacts 12a are placed at each of the signal connection portions as shown in FIG. 3 while a grounding plug contacts 12b is placed at each of the grounding connection portions as shown in FIG. 4. In this condition, the contact portions 16 of the signal plug contacts 12a and grounding plug contacts 12b are positioned such that one lateral sides of the contact portions 16 are exposed into the plug cavities 14 while the lead portions 18 of the respective contacts are exposed from the upper face of the plug housing 11. Thus, these plug contacts are aligned in the back-and-forth direction as shown in FIG. 2.

As shown in FIGS. 3 and 4, the central grounding plate 13 is press fit into the central protrusion 11c of the plug housing 11 in the back-and-forth direction. This grounding plate 13 is insulated from the lateral signal plug contacts 12a at the signal connection portions by the central protrusion 11c of the housing while being in contact with the grounding plug contacts 12b at the grounding connection portions, with the upper end of the central grounding plate 13 being fit into engaging slots 21 which are provided in the grounding plug contacts 12b. Therefore, the central grounding plate 13 is electrically connected only to the grounding plug contacts 12b.

The lead portions 18 of the signal plug contacts 12a and grounding plug contacts 12b, which portions are exposed from the upper surface of the base wall 11a of the plug housing 11, are mounted on a surface of a printed circuit board K1 which is provided for the plug connector as shown in FIG. 1. A pair of positioning pins 44 and 45 are provided on the upper face of the plug housing 11 each at the opposite end in the back-and-forth direction, and these positioning pins are inserted into the positioning holes which are provided on the printed circuit board K1 for accurate positioning of the plug connector onto the printed circuit board. After this positioning, the signal plug contacts 12a and the grounding plug contacts 12b are surface mounted on the printed circuit board by soldering each respective contact to a corresponding electrical pathway of a circuit pattern for signal transmission or for electrical grounding, respectively.

The receptacle housing 31 of the receptacle connector 30 comprises the base wall 31a, which is horizontally positioned (the portion illustrated with hatching in FIGS. 3 and 4 is only a central portion of the base wall 31a), and the lateral side walls 31b, which extend upward from the lateral ends of the base wall 31a. The upper end portions 31c of the lateral side walls 31b extend horizontally inward, so the receptacle cavity 34 is defined by the lateral side walls 31b and the upper end portions 31c.

As shown in FIG. 3, the signal receptacle contacts 32a includes a base portion 35, which extends horizontally, a contact portion 36, which extends upward from the inside end of the base portion 35 and curls inward at its upper end, an anchoring portion 37, which extends upward from the base portion 35 on the opposite sides of the contact portion 36, and a lead portion 38, which is provided at the outside end of the base portion 35. Furthermore, the contact portion 36 is laterally resilient around a supporting portion 36a which is the part near the base portion.

On the other hand, the grounding receptacle contact 32b includes the features of a pair of signal receptacle contacts 32a in a shape which is comparable to that of the signal receptacle contacts 32a combined into a one piece at the bottom of the electrical connector as shown in FIG. 4. Furthermore, the grounding receptacle contact 32b includes a pair of bifurcated holders 39, which extend upward at the lateral outside ends thereof.

In the base wall 31a of the receptacle housing 31, fitting slots 41 are provided in the up and down direction for attaching the signal receptacle contacts 32a and the grounding receptacle contacts 32b. During the assembly of the electrical connector, the anchoring portions 37 of the respective receptacle contacts are staked into these fitting slots 41. As a result, a pair of signal receptacle contacts 32a are placed at each of the signal connection portions as shown in FIG. 3 while a grounding receptacle contact 32b is placed at each of the grounding connection portions as shown in FIG. 4. In this condition, the contact portions 36 of the signal receptacle contacts 32a and grounding receptacle contacts 32b are positioned in the receptacle cavity 34 with a central space between the lateral respective pairs of contact portions 36. While both connector halves 10 and 30 are not mated, this space remains a little narrower than the lateral width of the central protrusion 11c of the plug housing 11. The lead portions 38 of the signal receptacle contacts 32a and grounding receptacle contacts 32b are exposed from the lower face of the base wall 31a of the housing. Thus, the lead portions 38 of the respective receptacle contacts are aligned in the back-and-forth direction as shown in FIG. 2.

As shown in FIGS. 2, 3 and 4, the lateral grounding plates 33 are attached on the lateral side walls 31b of the receptacle housing 31. Each lateral grounding plate 33 extends in the back-and-forth direction and has a bent portion 33a, which is formed by folding the upper end of the grounding plate inwardly. This bent portion 33a is press fit into a groove 42 which is provided at the upper end of each lateral side wall 31b of the housing, and thereby the lateral grounding plates 33 are mounted on the receptacle housing. In this condition, these lateral grounding plates 33 are insulated from the signal receptacle contacts 32a at the signal connection portions by the lateral side walls 31b of the housing while being in contact with the grounding receptacle contacts 32b at the grounding connection portions, with the lateral grounding plates 33 being fit into the grooves 40 of the holders 39 of the grounding receptacle contacts 32b (refer to FIG. 2). It should be noted that the lateral grounding plates 33 are electrically connected only to the grounding receptacle contacts 32b. Moreover, dents (or holes) 43 are provided on the outer faces of the lateral grounding plates 33 at the locations where the grounding receptacle contacts 32b are positioned in the back-and-forth direction.

The lead portions 38 of the signal receptacle contacts 32a and grounding receptacle contacts 32b, which portions are exposed from the lower surface of the base wall 31a of the receptacle housing 31, are mounted on a surface of a printed circuit board K2 which is provided for the receptacle connector as shown in FIG. 1. A pair of positioning pins 46 and 47 are provided on the lower face of the receptacle housing 31, each at the opposite end in the back-and-forth direction, and these positioning pins are inserted into the positioning holes which are provided on the printed circuit board K2 for accurate positioning of the receptacle connector to the printed circuit board. After this positioning, the signal receptacle contacts 32a and the grounding receptacle contacts 32b are surface mounted on the printed circuit board by soldering each respective contact to a corresponding electrical pathway of a circuit for signal transmission or for electrical grounding, respectively.

The plug connector 10 and the receptacle connector 30 constructed as described above are engaged by inserting and fitting the protruding portions of the receptacle connector 30, which are covered laterally with the grounding plates 33, into the plug cavities 14 of the plug connector 10, and thereby inserting and fitting the central protrusion 11c of the plug connector 10 into the space between the upper end portions 31c and then into the receptacle cavity 34 of the receptacle connector 30. While both the connector halves 10 and 30 are being brought into engagement, the contact portions 16 of the plug contacts, which are placed laterally on the opposite sides of the central protrusion 11c, meet, open and bend the contact portions 36 of the receptacle contacts, which are standing in the receptacle cavity 34, laterally outward around the supporting portions 36a of the contact portions 36, which experience elastic deformation. As a result, the contact portions 36 of the receptacle contacts 32 are retained in contact and electrical connection with the contact portions 16 of the plug contacts 12 with a sufficient contact pressure.

In addition, while the plug connector 10 and the receptacle connector 30 are being mated to each other, the arm portions 19 of the grounding plug contacts 12b are opened laterally by the insertion of the bent portions 33a of the lateral grounding plates 33 of the receptacle connector. When both the connector halves 10 and 30 are brought into complete engagement, the raised portions 19a of the arm portions 19 enter the dents 43 of the lateral grounding plates 33. As a result, both the connector halves 10 and 30 are firmly engaged and retained to each other. A click sound is generated at the insertion of the raised portions 19a into the dents 43, so the correct engagement of the connector halves 10 and 30 can be audibly confirmed.

The electrical connector assembly 1, which is used for signal transmission in this engaged condition, has an advantage in the prevention of crosstalk in the connector assembly. More specifically, the possibility of crosstalk which may be observable between the lateral pairs of signal plug contacts 12a is very small because of the provision of a strip line, i.e., the central grounding plate 13, which is positioned between the lateral pairs of signal plug contacts 12a and positioned between the lateral grounding plates 33, which are electrically grounded through the grounding plug contacts 12b and grounding receptacle contacts 32b to the electrically grounding pathways provided on the plug connector printed circuit board K1 and the receptacle connector printed circuit board K2. Therefore, the signal transmission characteristic of the electrical connector assembly 1 is superior to conventional electrical connectors. Moreover, electrical noise coming from the outside environment to the electrical connector assembly 1 is absorbed into the lateral grounding plates 33 of the receptacle connector 30, which are electrically grounded through the grounding receptacle contacts 32b to the electrically grounding pathway provided on the receptacle connector printed circuit board K2. Therefore, the electrical connector assembly 1 is also immune to outside noise.

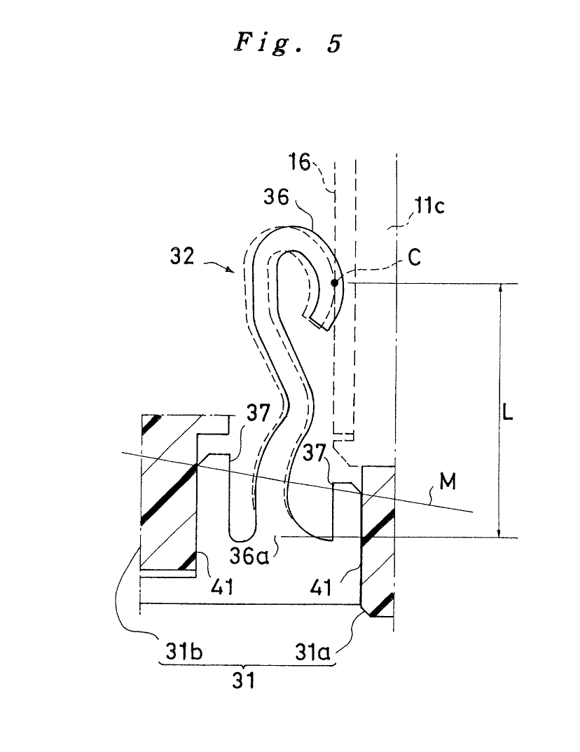

FIG. 5 shows the electrical contact (i.e., the receptacle contact 32) according to the present invention in free condition (in real line), i.e., without any elastic deformation, and in engaged condition (in broken line), i.e., with elastic deformation, which is caused by the meeting with the contact portion 16 of the plug contact. The electrical contact according to the present invention is configured such that the root portion 36a, which is a supporting portion for the elastic deformation of the contact portion 36, is positioned below the reference line M which extends through the upper ends of the areas where the anchoring portion 37 of the contact meets the fitting slots 41 of the housing as shown in the figure. In this configuration, the distance L from the root portion 36a of the contact portion to the point of contact C is relatively long with respect to the size of the electrical contact, which is maintained relatively small. As a result, the spring constant at the point of contact C (of the contact portion 36) is made relatively small. Therefore, this configuration substantially improves the uniformity of the contact forces which are generated in the contact portions of the receptacle contacts by the insertion of the plug connector 10 into the receptacle connector 30, so the insertion is smooth for the engagement of the connector halves. In summary, the non-uniformity of the spring constants created for the contact portions 36 due to dimensional inaccuracy during the fabrication of the receptacle contacts is kept relatively small with the distance L, which is made relatively long. Thus, the configuration for electrical contacts according to the present invention is advantageous in preventing contact failure of the electrical contacts. In other words, or in a reversed logic, if the configuration according to the present invention is applied, the size of the electrical contacts can be made smaller without shortening the length of the contact portions 36, which is advantageous in miniaturizing the electrical connector assembly 1.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This application claims the priority of Japanese Patent Application No.PH10-123330 filed on May 6, 1998, which is incorporated herein by reference.

What is claimed is:

1. An electrical contact, which is made of an electrically conductive plate material, comprising:
a base portion, whose lateral side ends are press-fit into a fitting slot that is provided vertically in a housing; and
a contact portion, which extends upward from a lateral central portion of said base portion, said contact portion being elastically bendable;
wherein:
a root portion of said contact portion, which is continuous with an upper end of said base portion, is positioned lower than a line which interconnects upper ends of said lateral side ends of said base portion which meet said fitting slot.

2. The electrical contact set forth in claim 1 wherein:
a receptacle connector comprises a plurality of said electrical contacts, which are aligned and retained in said housing;
when said receptacle connector is engaged with an intermatable plug connector, said contact portions of said electrical contacts are in contact with plug contacts which are retained in said plug connector; and
each of said contact portions is elastically deformed around said root portion while being in contact with a corresponding plug contact, so that a resiliency generated from said elastic deformation provides a contact force sufficient for said contact portion to be kept in contact with said plug contact.

3. An electrical contact, which is made of an electrically conductive plate material, comprising:
a base portion, which extends laterally;
a lateral pair of anchoring portions, which extend upward from lateral opposite ends of said base portion; and
a contact portion, which extends upward from a lateral central portion of said base portion, said contact portion being elastically bendable;
wherein:
for mounting said electrical contact in a housing, lateral side ends of said anchoring portions are press-fit into a fitting slot which is provided vertically in said housing.
